(19) United States
(12) Patent Application Publication
(10) Pub. No.: US 2009/0099945 A1
(43) Pub. Date: Apr. 16, 2009

(54) METHODS AND SYSTEMS FOR DIRECTORY-BASED PROGRAMMING

(76) Inventors: Robert Gendron, Salem, MA (US); John J. Powley, Plainville, MA (US); Peter Sage, Stephentown, NY (US)

Correspondence Address: General Electric Company;GE Global Patent Operation, PO Box 861, 2 Corporate Drive, Suite 648, Shelton, CT, 06484, US

(21) Appl. No.: 11/871,475

(22) Filed: Oct. 12, 2007

(51) Int. Cl. G06Q 40/00

(52) U.S. Cl. 705/35

(57) ABSTRACT

A method for integrating assets of an automated system includes defining base services of the automated system. A directory of assets within the automated system is provided. A common name space associated with each asset in the directory is also provided. Each asset in the directory is linked using the common name space. The assets are integrated by extending at least one asset to another asset to perform a base service of the automated system.

### BACKGROUND OF THE INVENTION

This invention relates generally to automated systems and, more particularly, to directory based programming for an automated system.

Generally, automated systems include a plurality of assets that are used to perform various base services of the automated system. The assets are generally grouped to perform a specific base service. Typically, an asset is utilized only to perform its specific base service and is not extended to perform a base service of another group. In some known systems the assets cannot be extended because they are not linked to one another.

Often, an asset useful for one base service may be useful for a second base service of the automated system. Unfortunately, because the asset is grouped based only on its primary base service, the asset cannot be extended to a secondary base service. As a result, the efficiency and cost effectiveness of the automated system is decreased.

### BRIEF DESCRIPTION OF THE INVENTION

In one aspect, a method for integrating assets of an automated system includes defining base services of the automated system. A directory of assets within the automated system is provided. A common name space associated with each asset in the directory is also provided. Each asset in the directory is linked using the common name space. The assets are integrated by extending at least one asset to another asset to perform a base service of the automated system.

In another aspect, a system for integrating assets of an automated system is provided. The automated system is configured to perform base services. The system includes a directory of the assets. A mechanism for providing a common name space associated with each asset in the directory is provided. A publishing algorithm links each asset using the common name space. A system extender integrates the assets by extending at least one asset to another asset to perform a base service of the automated system.

In yet another aspect, an automated system configured to perform base services is provided. The system includes a plurality of assets and a directory of the assets. A mechanism for providing a common name space associated with each asset in the directory is provided. A publishing algorithm links the assets using the common name space. A system extender integrates the assets by extending at least one asset to another asset to perform a base service of the automated system.

### BRIEF DESCRIPTION OF THE DRAWINGS

FIG. 1 is a schematic view of an exemplary automated system.

FIG. 2 is a schematic view of the integration system shown in FIG. 1.

### DETAILED DESCRIPTION OF THE INVENTION

A system for integrating assets of an automated system is provided, wherein the automated system is configured to perform base services. In the exemplary embodiment, the system includes a directory of the assets. The assets include machines included in the automated system and programming services that are used to support the machines. The system links the assets based on common programmability and integrates the assets to perform base services of the automated system.

In the exemplary embodiment, standard Lightweight Directory Access Protocol directory structures are extended to support the resources, and associated support programs for assets of a large scale distributed manufacturing operation and/or automation application. Accordingly integration of the system is simplified. In one embodiment, all the assets listed in the directory are provided a global name space that is used for communicating between the assets. In another embodiment, the assets in the directory are linked by a common system and custom programmability. Further, directory assets are extended with system extender objects that simplify integration of elements into solutions. Moreover, the system supports a registration strategy that enables dynamic expansion of the asset set, the system extenders and solutions. Accordingly, the system delivers extended programmability of the assets upon request of a user.

Although the present invention is described with respect to automated systems, as will be appreciated by one of ordinary skill in the art, the present invention may also apply to any system and/or manufacturing process. Further, although the present invention is described with respect to a directory of assets, as will be appreciated by one of ordinary skill in the art, the present invention may also apply to any accumulation of assets that operates as described herein.

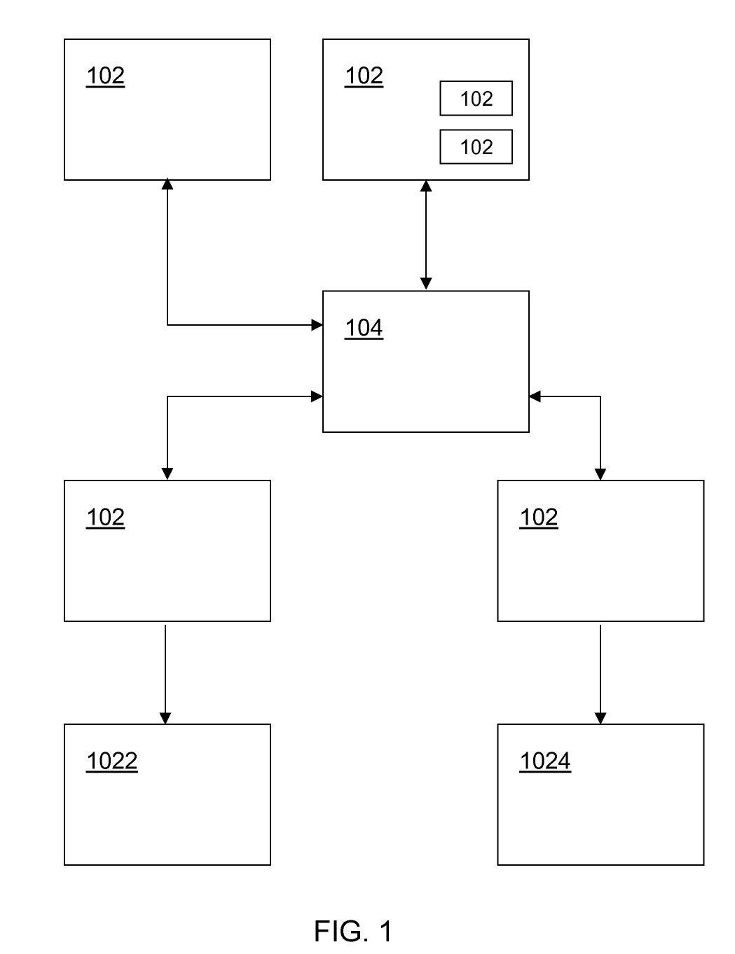

FIG. 1 is a schematic view of an exemplary automated system 100. In the exemplary embodiment, automated system 100 is configured to perform at least one base service. More specifically, the base service includes power generation, a manufacturing process, and/or any suitable service performed by an automated system. Automated system 100 includes a plurality of assets 102. In one embodiment, each asset 102 is configured to perform a selected base service. In an alternative embodiment, a group of assets 102 operate together to perform one or more base services. In a further embodiment, at least one asset 102 is configured to perform more than one base service. In the exemplary embodiment, each asset 102 includes a machine used in the automated process, programming support for the machine, and/or any other physical or logical component that is used as part of a base service 1022 or 1024. System 100 also includes an integration system 104 that is configured to integrate assets 102.

During operation, assets 102 are operated to perform one or more base service. More specifically, each asset 102 is configured to perform certain tasks (b1,b2, . . . ,bn). Integration system 104 operates to integrate assets 102 to improve the operation of system 100 and improve the performance of the base service. More specifically, integration system 104 expands each asset 102 such that each asset 102 performs functions outside the scope of its original base service. Accordingly, the operation of each asset 102 is optimized to improve the performance of the base service.

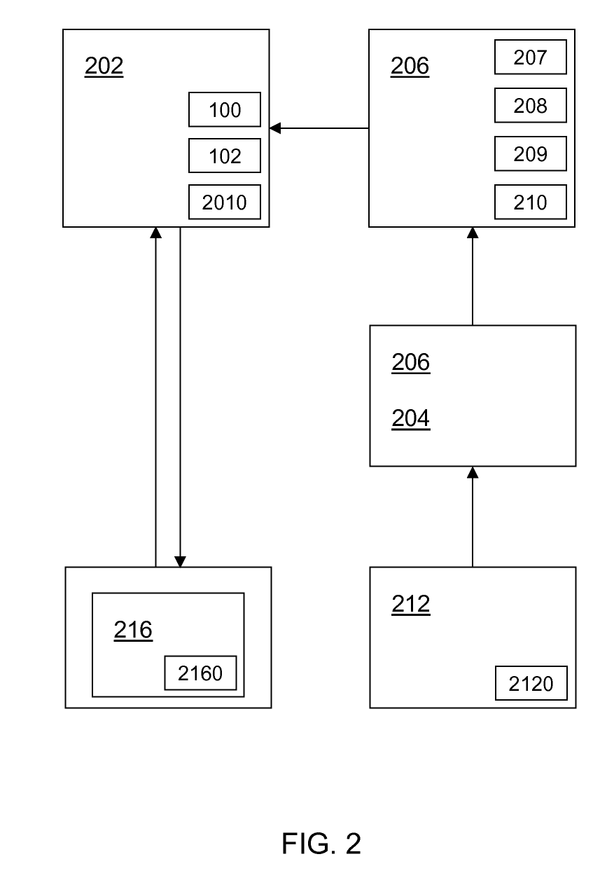

FIG. 2 is a schematic view of integration system 104. System 104 includes a directory 202, an installation mechanism 204, a set of publishing algorithms 206, a set of system extenders 208, and a system programming support 210.

In one embodiment, directory 202 is part of a Lightweight Directory Access Protocol (LDAP). In a particular embodiment, directory 202 is a directory storage mechanism, for example, an LDAP server. In the exemplary embodiment, directory 202 is a directory of assets 102, such as the machines included in automated system 100, the server computers of automated system 100, and the available programming services supported at a machine and/or server computer.

Further, in the exemplary embodiment, installation mechanism 204 includes any mechanism configured to install publishers for constructing directory 202. More specifically, the enumeration of assets 102 (end equipment, documents, logical entities such as displays, data sources, personnel, work orders, formulas, and/or processes) are published. Further, the programmability of the assets 102 is linked to the programming services of each asset 102.

In the exemplary embodiment, the set of publishing algorithms 206 includes a publisher for the machines (classification and machine access properties), a publisher for the service programmability (service entry points and classification), a scheme to develop a publisher for asset content (classification, access properties), and a scheme to map the asset content to system programming support 210. In one embodiment, assets 102 and system programming support 210 are unified into a common namespace such that all assets 102 are addressable with standard LDAP services. Accordingly, by having a common namespace, assets 102 can be linked based on the common namespace.

In the exemplary embodiment, assets 102 are linked using system extenders 208. Each system extender 208 allows for extending the properties and the classifications of the asset content. System extenders 208 may also be used to control traffic patterns within the system. Further, in one embodiment, system extenders 208 support route selection (optimization of possible route patterns).

In the exemplary embodiment, a solution map is provided to define how system extenders 208 and assets 102 are bound. More specifically, system extenders 208 provide binding and system extension support for forming integrated solutions for operating automated system 100. Accordingly, in the exemplary embodiment, system extenders 208 include installable bundles of programming that are provided by the system environment. In principle, system extenders 208 are described as standard system services similar to the base system services.

In the exemplary embodiment, system extenders 208 operate on directory content. More specifically, system extenders 208 are registered at key points of influence in the directory. Accordingly, solutions for system 100 are woven together as opposed to statically coded into solutions. With this strategy, existing solutions are modified to impose different behavior according to operating conditions.

Further, traffic behavior is supported by traffic extenders. Accordingly, the behavior of a collection of objects may be arbitrarily extended to provide system programming support where none is available through the base set of objects. For example, distributed system security can be built against a network of existing resources where none of the resources are security aware. System extenders 208 are registered at the nodal access points and can observe and control system behavioral patterns.

In one embodiment, a collection of system extenders 208 can be written to recognize other participants and conditions. These advanced system extenders 208 are used to coordinate behavior in a system for which no such behavior exists natively.

In the exemplary embodiment, the classification characteristics 2010, 2160, and 2120 define attributes that may be associated with objects that are known to the directory. The namespace defines a set of attributes that are associated with a specific application or an object class. For example, a Security namespace might define a set of attributes or characteristics that includes, but is not limited to “Read”, “Write”, “Execute”, “Delete”, and “Extend”. Each of the elements are addressable, respectively, as “Security:Read”, “Security:Write”, and “Security:Extend”. In one embodiment, an interpretation of the value “Security:Read” that is associated with an object is that if it is “true” that “Security:Read” access is allowed for the object the object can be read. “Security:Write” associated with an object is the negation of “Security:Write” and would indicate that if it is “false” that “Security:Write” access is allowed the object cannot be written.

In the exemplary embodiment, the classification characteristics that span the space of an application are grouped into a number of classification namespaces. A classification namespace defines a set of conditions or attributes that are known to be “true” or “false” about the characteristics when they are applied. In the exemplary embodiment, the value of an attribute is either “true”, “false”, or “undefined”. Each object in the directory is associated with one of zero, one, or more attributes. If an object has an attribute associated with it, then the value is “true”, “false” or “undefined”. If an attribute is not associated with an object or if the value of the attributed is “undefined”, nothing is inferred about the object with respect to the undefined attribute. If a value for an attribute is defined, then it is either “true” or “false” and adopts the meaning associated with the attribute in the “true” or “false” state.

In the exemplary embodiment, there are a collection of namespaces {N1,N2, . . . ,Nm}. Each namespace Ni, i=1, . . . m, consists of a set of characteristics or attributes {a1,a2, . . . ,an}. For example, in an embodiment using a Security namespace, a directory object could be defined with “Security:Write” and “Security:Delete” such that the object is only accessed if the user attempting to access the object has “Write” and “Delete” privileges. The namespaces {N1,N2, . . . ,Nm} define such topics as, but not limited to, Security, Display, and Equipment. The Display characteristics define the abstract display characteristics for the object, such as, but not limited to, visible, iconic, and streaming, i.e. “Display:visible”, “Display:iconic”, and “Display:streaming”. Further, Equipment defines the characteristics of the equipment, such as, but not limited to, electronic, computing, and sensing, i.e. “Equipment: electronic”, “Equipment: computing”, “Equipment:sensing”. Accordingly, an example of an object described by the characteristics might be “Security:read, Display:visible, Display:streaming, and Equipment:sensing” for a composite object that can be read, is visible as a display entity, can be viewed as a streaming display entity, and is a piece of equipment that supports sensing.

For Active Directory LDAP based namespaces, a classification attribute is defined that stores the multivalued set of characteristics for an object and the values of the characteristics are supported by the Directory Publisher. Each object publisher supplies the set of characteristics that describe the object and the object behaviors. It is a direct and simple matter to then define standard LDAP queries that will evaluate large sort order sets of objects from LDAP directories. For example an LDAP query like: “cls=Display:*” would find all objects in the directory target that involved a Display attribute of some kind.

An LDAP query like: “&(objectClass=equipment)(I(cls=Display:streaming)(Equipment:sensing)))” would find from the LDAP class of objects called equipment, all the equipment that supported “Display:streaming” for an Equipment functional area called sensing. Through the use of LDAP, composite queries can be written that quickly sort through the characteristics of the objects for an application space with large numbers of objects.

Large complex systems may have dozens of such classification namespaces and, collectively across namespaces, potentially hundreds of distinguishing attributes or characteristics. It is the role of a model that is applied to a namespace to restrict the combinations of the attributes that are possible according to the requirement of the object behavior that is modeled in the application. It is also the role of a model to define how a system might react when an object is transitioning from one set of characteristics to another set of characteristics. The model also controls what operators and operations cause the system to transform from one set of characteristics to another.

All namespaces or partial combinations of namespaces can be combined into large binary radix sets consisting of ones, wherein the value must be 1, zeroes, wherein the value must be 0, and *, wherein the value is ignored, for large scale high speed search optimizations. For example a composite namespace like: “Security:Read,Security:Write,Security:Execute,Security:Delete,Security:Extend” and “Display:visible, Display:iconic, Display:streaming” can be reduced to the simplistic 7 bit stream value space {1111111}. For example, “P={1**0*10}” applied as a query would be the statement: find all the elements such that “Security:Read” is true, “Security:Write” and “Security:Execute” are ignored, “Security:Extend” is false, “Display:visible” is ignored, “Display:iconic” is true and “Display:streaming” is false. In actual practice, bit patterns like “P={1**0*10}” are expressed as two bit patterns such as: (a) the set of conditions that must be true: T={1000010} if the value of the bit is 1, and (b) the set of conditions that must be false: F={0001001} if the value of the bit is 1. It should be noted that the first pattern T={1000010} imposes that “Security:Read” is true and that “Display:iconic” are true while the second pattern F={0001001} imposes that “Security:Extend” is false and that “Display:streaming” is false. Nothing is said about any other condition. In other words only logically assertive statements are emphasized for the value 1 in a set like T or F and the 0 values in T or F are ignored otherwise. The 0 values common to both T and F of this paragraph are the elements of P that are “*”, that is, to be ignored.

For a given application, an object in the directory has a collection of characteristic values from a number of Namespaces that qualify the use of the object. In some cases the classifications express constraints; in other cases classifications express capacity or use of the objects. It is the interpretation by the application that determines the meaning of the characteristics.

In one embodiment, system extenders 208 include route extenders 209 that examine routing options through a network of objects to determine the best use of assets 102 and system extenders 208 to optimize the usage of resources. For example, many different transport paths might be available, with varying cost considerations. Route extenders 209 evaluate the best paths according to cost considerations and system traffic loads. Solution maps define how addressable elements are combined to produce the integrated results. A static map defines the fixed set of resources that are required to achieve a system goal (i.e. base service). A dynamic solution map is composed of queries and selection criteria. When a solution map is applied, it is used to operate on known system extenders 208 to produce the desired integrated result.

A solution map is a collection of queries, classifiers and binders that define what is operated on and how the elements of resources matching the queries are combined into execution units to achieve the applications goals. The queries are applied to a sub space of the directory and are qualified searches that define the characteristics of the objects that are applicable. For example a process solution map might have a set of queries based on classifications such as: “Q1=(Equipment:Mixer,Equipment:Press,Equipment:Stacker)”, “Q2=(Display:visible, Display:streaming,Display:Equipment)”, and “Q3=(Operator:Press,Operator: Mixer)”. The classification queries Q1, Q2 and Q3 are applied to the directory to produce, respectively, a Q1 that determines the set of equipment that is a mixer with a press and supports stacking, and a Q2 that selects from the set of displays those that are visible through a Display device, and has display streaming support and can support the display of equipment information. Q3 selects operators with the required rating as a Press operator and Mixer operator. The classifiers and binders are solution parts that accept the Q1, Q2, and Q3 search results and bind those parts into the sequence of operations required to complete the process request. The sequencing logic is a pattern embedded in the classifier and the binders provide the means to link the solution pattern elements.

The common pattern in system programming support used to build applications is as follows: (1) a query or set of queries define search patterns for the resources that are required by a solution, (2) the queries are applied to the directory in whole or in part to produce search results, and (3) the search results define resources from the directory that are then located and assembled locally according to the construction rules defined by the solution maps. The system programming support enables the definition of the solution queries, the solution maps and supports the construction of the local allocation of the assets to support the final application result. In other words the system programming support facilitates organizing locally, all the global directory resources, as necessary to meet the original application design goals.

In the exemplary embodiment, system programming support 210 is used to access the programmability of system 100. System programming support 210 operates on directory 202 and provides a direct callable interface or basic operation and/or contextual information to qualify a search pattern. More specifically, a basic programmability of programming support 210 provides service provider access throughout the directory, access of programmability that is mapped to the assets, access of contextual programmability, and a solution map binder. In the exemplary embodiment, the access to the contextual programmability gives the system provider access that aggregates system services according to a context request. Further, in the exemplary embodiment, the solution map binder provides the access to combine directory assets and programmability.

System 104 is configured to be used with a plurality of computing machines that are integrated as part of a solution. System 104 is used to integrate the machines, the base services (programming support) that are installed on the machines, and the physical or logical components used with the machines. Accordingly, the services of each of these machines are linked into programs (solutions) that coordinate the programmability of the physical and logical components to achieve a base service of the automated system. In particular, system 104 extends and binds the base service elements of each asset to achieve solutions through integration of the asset.

The machines in the directory are registered according to the base services that are performed by the automated system. Further, the programmability of the base services is described (classified) in the directory. Moreover, the logical and physical components listed in the directory are registered and classified and linked with the assets configured to perform the base services. The system extender objects bind the assets into system solutions. More specifically, solution maps bind the extended assets into the solutions.

System 104 is configured to enumerate each asset and its related programmability for the elements within the directory, obtain a description of the programmability for the elements within the directory, and obtain the programmability for the assets or services within the directory according to a search criteria (classification). Solution maps extend the directory assets that meet a solution objective and observe and control the system traffic patterns. The solution maps also extend existing assets or solutions, and route traffic through the network of extended objects.

System 104 is capable of linking the assets by providing a unified name space for each programming asset and programming model. More specifically, the system is built on extenders that can be modified over time and expanded from one product delivery cycle to the next. Further, the system includes the ability to add extenders that can add system level features, for example security, control, observations, analysis, etc. Accordingly, the system assets are woven together to form more advanced solutions. Further, distribution, updates and modifications of the solution space are inherent in the system design. Specifically, the code parts and content are registered with the directory and the consumer obtains the most recent implementation as new implementations become available. Moreover, 3rd party assets can be readily adapted for immersion into the distributed system programming environment. Specifically, the native programming offered by 3rd party assets can be augmented by the extenders. Custom extenders can then be authored to extend the 3rd party assets.

In one embodiment, extenders can be defined and added to adapt the system behavior to constrained situations, such as security access and resource use patterns. For example, the traffic patterns may be adjusted, as necessary to morph the system behavior to the desired constrained behavior. Further, system elements can be added dynamically and the aggregated system reacts to the system changes according to policy design rules and solution matching patterns.

In another embodiment, contextual models can be written that blend system goals and application goals to arrive at the end solution. In particular, the traffic pattern system that is built into the programming layer significantly simplifies customizing behavior. Further, in the exemplary embodiment, each system and/or asset can “see” or locate each other system and/or asset. The global directory makes it possible for all systems to observe the directory in order to realize the existence of all other existing systems in a uniform way. Accordingly, cross system integration is greatly simplified for each element programmed to a single global view as opposed to a point to point view. Moreover, a global system cross reference table is readily developed that allows for locating all cross system access points.

In summary, the invention provides the means to link assets with base programming services to compose solutions that make best use of system resources.

In one embodiment, a method for integrating assets of an automated system includes defining base services of the automated system. A directory of automated system assets within the automated system is provided. A common name space for the address space of each asset is provided. The assets in the directory are linked to a common system using the common name space. The assets within the common system are then integrated by extending at least one asset to another asset to perform a base service of the automated system.

In the exemplary embodiment, providing a directory of the automated system assets includes providing a directory of machines within the automated system. Further, in the exemplary embodiment, linking the assets in the directory to a common system includes linking the assets with a common programmability. Moreover, in the exemplary embodiment, integrating the assets includes integrating the assets using the common programmability.

In one embodiment, the method includes monitoring the assets during performance of a base service to facilitate improving asset integration. In another embodiment, the method includes defining classifications of assets within the common system. In such an embodiment, integrating the assets within the common system includes integrating a first classification of assets with a second classification of assets.

As used herein, an element or step recited in the singular and proceeded with the word a or an should be understood as not excluding plural said elements or steps, unless such exclusion is explicitly recited. Furthermore, references to one embodiment are not intended to be interpreted as excluding the existence of additional embodiments that also incorporate the recited features.

Exemplary embodiments of systems and methods for directory based programming are provided. The systems and methods shown are not limited to the specific embodiments described herein, but rather, components of the system may be utilized independently and separately from other components described herein. Further, steps described in the method may be utilized independently and separately from other steps described herein.

While the invention has been described in terms of various specific embodiments, those skilled in the art will recognize that the invention can be practiced with modification within the spirit and scope of the claims.

What is claimed is:

1. A method for integrating assets of an automated system, said method comprising:
defining base services of the automated system;
providing a directory of assets within the automated system;
providing a common name space associated with each asset in the directory;
linking each asset in the directory using the common name space;
integrating the assets by extending at least one asset to another asset to perform a base service of the automated system.

2. A method in accordance with claim 1 wherein providing a directory of assets further comprises providing a directory of machines within the automated system.

3. A method in accordance with claim 1 wherein linking each asset in the directory further comprises linking the assets with a common programmability.

4. A method in accordance with claim 3 wherein integrating the assets further comprises integrating the assets using the common programmability.

5. A method in accordance with claim 1 further comprising monitoring the assets during performance of a base service to facilitate improving asset integration.

6. A method in accordance with claim 1 further comprising defining classifications of assets.

7. A method in accordance with claim 6 wherein integrating the assets further comprises integrating a first classification of assets with a second classification of assets.

8. A system for integrating assets of an automated system, wherein the automated system is configured to perform base services, said system comprising:
a directory of the assets;
a mechanism for providing a common name space associated with each asset in the directory;
a publishing algorithm for linking each asset using the common name space; and
a system extender for integrating the assets by extending at least one asset to another asset to perform a base service of the automated system.

9. A system in accordance with claim 8 wherein each asset comprises a machine within the automated system.

10. A system in accordance with claim 8 wherein the publishing algorithm links each asset with a common programmability.

11. A system in accordance with claim 10 wherein the system extender integrates the assets using the common programmability.

12. A system in accordance with claim 8 wherein the system extender monitors the assets during performance of the base service to facilitate improving asset integration.

13. A system in accordance with claim 8 wherein the publishing algorithm defines classifications of assets.

14. A system in accordance with claim 13 wherein the system extender integrates a first classification of assets with a second classification of assets.

15. An automated system configured to perform base services, said system comprising:
a plurality of assets;
a directory of the assets;
a mechanism for providing a common name space associated with each asset in the directory;
a publishing algorithm for linking the assets using the common name space;
a system extender for integrating the assets by extending at least one asset to another asset to perform a base service of the automated system.

16. An automated system in accordance with claim 15 wherein each asset comprises a machine within the automated system.

17. An automated system in accordance with claim 15 wherein the publishing algorithm links each asset with a common programmability.

18. An automated system in accordance with claim 17 wherein the system extender integrates the assets using the common programmability.

19. An automated system in accordance with claim 15 wherein the system extender monitors the assets during performance of the base service to facilitate improving asset integration.

20. An automated system in accordance with claim 15 wherein:
the publishing algorithm defines classifications of assets; and
the system extender integrates a first classification of assets with a second classification of assets.
